(19) United States
(12) Patent Application Publication
(10) Pub. No.: US 2014/0228164 A1
(43) Pub. Date: Aug. 14, 2014

(54) Collector of rotational movement from tangential weight and spring force

(71) Applicant: Jorge Luis Sarmiento, El Paso, TX (US)

(72) Inventor: Jorge Luis Sarmiento, El Paso, TX (US)

(21) Appl. No.: 13/815,235

(22) Filed: Feb. 12, 2013

(51) Int. Cl. H02K 7/18; F16H 13/04

(52) U.S. Cl. CPC H02K 7/1807; F16H 13/04; F03G 7/10
USPC 476/67; 74/DIG. 9

(57) ABSTRACT

This embodiment of at least two free rotating wheels (108) and (208) rotating on the periphery of each other. A free rotating wheel (108) is mounted on a rigid column (104) and base (301). The base allows a second wheel (208) mounted on a Suspension Mechanism (204) which permits the second wheel to rotate on the periphery of the first wheel. The suspension mechanism (204) is made of rigid materials, articulated and aligned to allow displacement in the vertical direction, but not in any other direction. The suspension mechanism maximizes the tangential component of the weight mass force attached to wheel (208) and spring force (288) that would entice a simultaneous rotation on both free rotating wheels. Additionally, a coupling mechanism on suspension base (204) allows for transmitting the rotational movement to a third device such as electricity generator (202) or water pump. Other embodiments are described and shown.

### BACKGROUND—PRIOR ART

The following is a tabulation of some prior art that presently appears relevant:

U.S. Patents

| Patent Number | Kind Code | Issue Date | Patentee |
|---|---|---|---|
| 8,262,316 | B2 | Sep. 11, 2012 | Slater et al. |
| 7,573,147 | B2 | Aug. 11, 2009 | Sayed Karim |
| 4,284,899 | B2 | Aug. 18, 1981 | Donald Bendiks |

U.S. Patent Application Publications

| Publication Nr. | Kind Code | Publ. Date | Applicant |
|---|---|---|---|
| US20120212948A1 | A1 | Aug. 23, 2012 | Martin Riddiford |

Foreign Patent Documents

| Foreign | | European | | App or |
|---|---|---|---|---|
| Doc. Nr. | Country | Class | Pub. Dt. | Patentee |
| EP1848098A1 | Germany | H02K 53/00 | Oct. 24, 2007 | Berend Haan |

### Non Patent Literature Documents

Bataglia, Jeff, Greace Post.com E-Magazine, “Tom Farmer's Gravity Generator” (Aug. 30, 2012)

### FIELD OF THE INVENTION

This disclosure relates to the generation of circular motion on wheels, generated by the controlled linear tangential displacement of weight or sprung mass.

Although rotational movement has many applications, water pumps, conveyors, etc. the most common use is in electricity generation, to provide the relative motion between magnets and conductor coils.

The present invention relates to a method to gather rotational movement, from the relative location of two different free wheels of equal or different diameters, and parallel axis. Both wheels rotating in contact with each other on their perimeter, where the first wheel is mounted in a fix column and the second wheel is mounted on a suspension mechanism or sliding column.

### SUMMARY

In accordance with one embodiment an originator of rotational movement comprises a first free wheel, able to rotate in any direction—mounted in a fixed column—; and a second wheel mounted on a suspension column and rolling on the periphery of the first wheel, its center, located offset from the vertical central line or dead points. The smaller or second wheel is allowed to move only in the vertical direction, and allowed to follow the contour of the larger wheel while rotating freely.

The base or frame holds the predetermined proper dimensions for the separation between the center points of both wheels. In other words: the distance between the fix column and the suspension column is maintained by the rigid frame or base.

The simultaneous rotation is originated by the natural propensity of the weight on the suspension column to move downward. However, the large free rotating wheel is precisely located in the direction of such downward weight force. The larger wheel is placed in such a way that the weight does not fall in the “vertical dead diametrical line”, but almost tangential to the larger wheel.

The very same dimensional arrangement can be improved by providing a larger tangential force on the first wheel. Such larger tangential force does not come only from the weight of the smaller suspended wheel but from spring force. Sprung mass can be added to the second wheel by way of the suspension column, in order to provide a major tangential force and speed rotation on the first wheel.

A spring mechanism is mounted on the suspension arm, and attached to the second wheel mounted on the sliding column, to provide the increased tangential force over the first wheel.

The invention can use the weight of the external device or previous invention, requiring the rotational input, generator or pump, to provide the weight that the smaller wheel requires to rotate in the periphery of the larger wheel.

The invention can also use springs attached to the base holding the smaller second wheel to keep the wheel in contact with the perimeter of the first base wheel.

The invention can use the intrinsic weight of the smaller wheel, or augmented wheel weight of the smaller wheel, to rotate in the periphery of the larger wheel, and generate the rotational output required by a third device.

The rotational energy is to be used by other devices, or previous inventions, that require rotational movement input, such as: pumps, electric generator, conveyor or pulleys, but not limited to those.

The invention can have a multiplicity of magnets and coils, known as an electricity generator, mounted on the very same wheels that are being forced to rotate by the weight and sprung mass; avoiding the need for the third piece known as the electricity generator.

However, the present design is presented in order to take advantage of the availability of out of the shelf standard industrial components, which due to mass production can be of lower cost.

In the other hand when the multiplicity of magnets and coils are imbedded in the very same wheels, the efficiency could be higher since relative movement between magnets and coils can be increased by having a parallel arrangement, rotating in opposing directions, and therefore adding up the relative speed of the wheels with respect to each other, instead of the relative speed when one wheel is a rotor, and the other an stator.

### ADVANTAGES

Accordingly several advantages of one or more aspects are as follows: to provide rotational movement to third devices requiring rotational input.

Devices requiring rotational input can be water pumps, conveyor belts or electricity generators. The ratio of diameters between wheels and weight and size of the third device—generator—are inputs that determine the amount of rotational momentum. The embodiment is more efficient when the weight of the third device helps to increase the weight of the hamster smaller wheel or the suspension column.

The generation of electricity, is accomplished by coupling, a generator to the smaller hamster wheel mounted on the suspension column, as shown in FIG. 1.

Other advantages of one or more aspects will be apparent from consideration of the drawings and ensuing description. The optimal geometry, frictionless bearings, frictionless column, and maximum tangential force transmission between gears by means of précised machined gears, produces an electricity output from the collector of rotational movement.

### FIGURES—DRAWINGS

The novel features and believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 Shows an exploded perspective view of the “Collector of Rotational Movement” assembly in accordance with a preferred embodiment of the invention, but not limited to the second wheel or smaller wheel in the “inner” perimeter of the larger wheel.

FIG. 2 Shows an exploded perspective view of the “Collector of Rotational Movement” assembly in accordance with a preferred embodiment of the invention, but not limited to the smaller wheel in the “outer” perimeter of the larger wheel.
FIG. 2A Perspective view of a collector of rotational movement.
FIG. 2B Schematic detail of inner spring mechanism within support column.

FIG. 3 Shows a front and side view of the “Collector of Rotational Movement” assembly, In this case showing the hamster wheel or heavy smaller wheel rotating in the outer perimeter of the larger free rotating wheel.
FIG. 3A Shows the front view of the device.
FIG. 3B Shows a side view of the device.

FIG. 4. Shows the distance between center of the wheels 315 and the projected distance in the horizontal plane 303, in two possible set ups, but not limited to it.
FIG. 4A diagram showing secondary small wheel in the inner perimeter of the first wheel.
FIG. 4B diagram showing secondary small wheel in the outer perimeter of the first wheel.

FIG. 5. Shows the direction of rotation of the wheels in two possible set ups.
FIG. 5A Rotation direction when secondary small wheel is on the first wheel inner Perimeter.
FIG. 5B Rotation direction when secondary small wheel is on the first wheel outer perimeter.

FIG. 6 Shows direction of weight force and direction of augmented sprung mass force.
FIG. 6A Diagram showing the direction of weight force.
FIG. 6B Diagram showing the direction of weight force plus spring force.

FIG. 7 Shows the principle that a major tangential rotational force 405 is accomplished, when the
FIG. 7A Angle 401 is closer to vertical line provides smaller tangential component force.
FIG. 7B larger angle 401 of 85° from vertical line 401 provides larger tangential force.

FIG. 8 Shows another arrangement where the suspension mechanism is a rotating arm.
FIG. 8A Rotating arm, wheel rolling in inner perimeter, and only weight force.
FIG. 8B Rotating arm, wheel rolling in outer perimeter, and added sprung mass force.

FIG. 9 Shows an arrangement where the orientation of the embodiment is not in the regular horizontal and vertical directions.

FIG. 10 Shows a perspective view of an arrangement where the small or secondary wheel is suspended from a rotating arm, and rolls on the outer periphery of the first wheel.

### FIGURES—REFERENCE NUMERALS

101. Dead force line, the diametrical line comprising the center of the fixed wheel, top and bottom point of the same wheel.
103. Top most point of wheel mounted on fixed base.
104. Fixed base for free rotating wheel, or first wheel.
105. Bottom most point of wheel mounted on fixed base.
108. Wheel mounted on a fixed base.
202. Electric generator.
204. Suspension column or sliding column, suspension or rotating arm for free rotating, second or hamster wheel.
205. Sprung mass and direction of force.
207. Direction of free movement allowed by a suspension arm or sliding column base.
208. Wheel mounted on sliding columns or suspension column, named: hamster wheel.
209. Radial direction, is a direction of movement not allowed by a rotating arm, or suspension base.
211. Direction of free movement allowed by an arm.
288. Spring mechanism.
301. Base
303. Distance between centers of the two wheels, projected to a horizontal plane.
315. Distance between centers of wheels.
401. Angle of contact of both wheels with respect to the vertical dead line.
403. Direction of force, weight force or sprung mass force.
405. Tangential component of weight or spring force, dependant on the angle of contact.

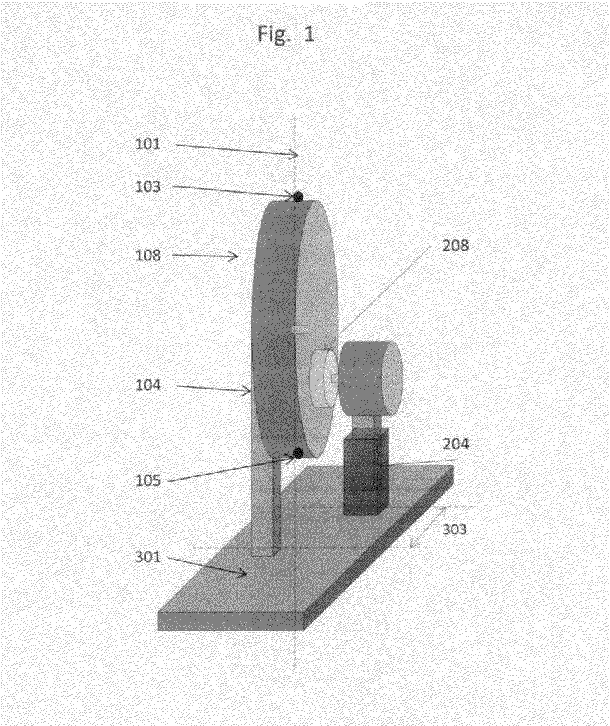

### DETAILED DESCRIPTION—FIG. 1 TO FIG. 10—EMBODIMENT

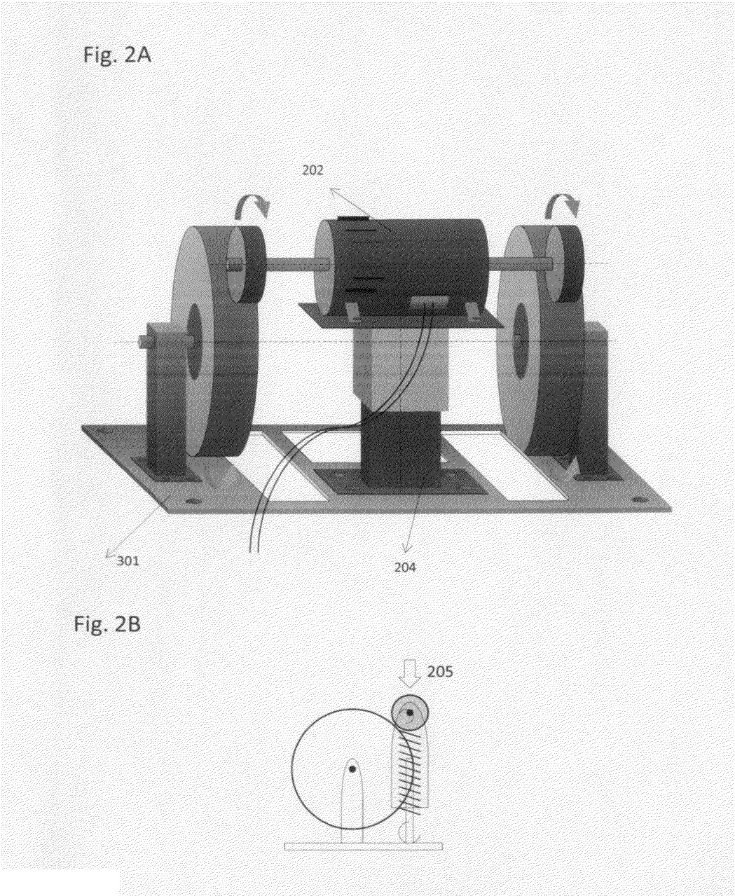

One embodiment of the “Collector of rotational movement” is illustrated in FIG. 1 (perspective view), and another possible arrangement of the collector of rotational movement is shown in FIG. 2A (perspective view).

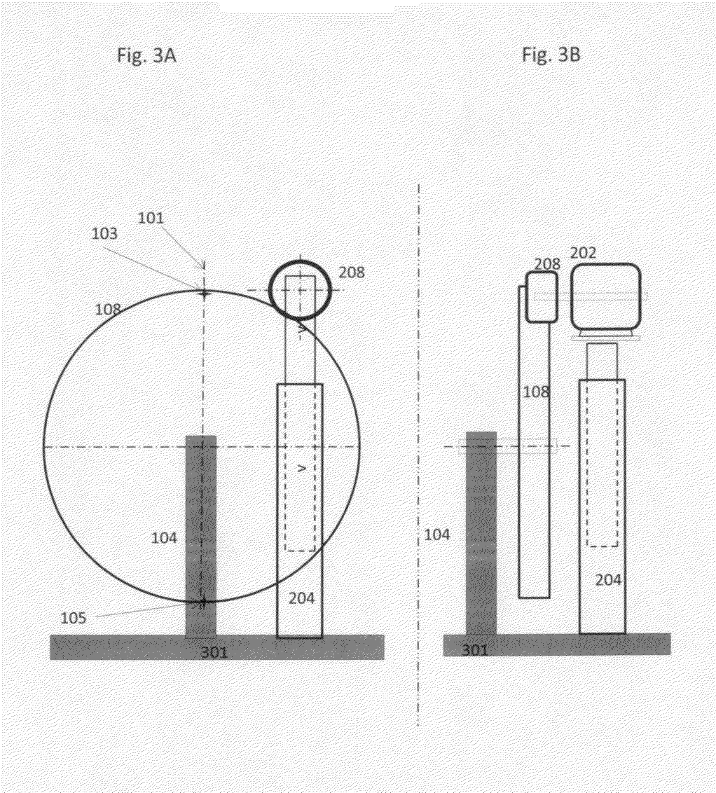

Components of the embodiment are better shown in FIGS. 3A and 3B, as follows: The device has a base 301 of predetermined dimensions and material, which provides the means to support at least two wheels 108 and 208, of either: equal or different diameters, one wheel rotating on the perimeter of the other wheel.

The base or support can consist of at least two columns, but not limited to. One fix column 104 supports a larger wheel 108. The column is fixed in place and the wheel is freely rotating in either direction—clockwise or counters clockwise—. The second column or suspension arm 204 can slide up or down but not in the horizontal direction, and holds the free rotating wheel 208 at the desired distance 303. Column 204 is a mechanism that allows displacement in only the vertical direction but not in any other direction.

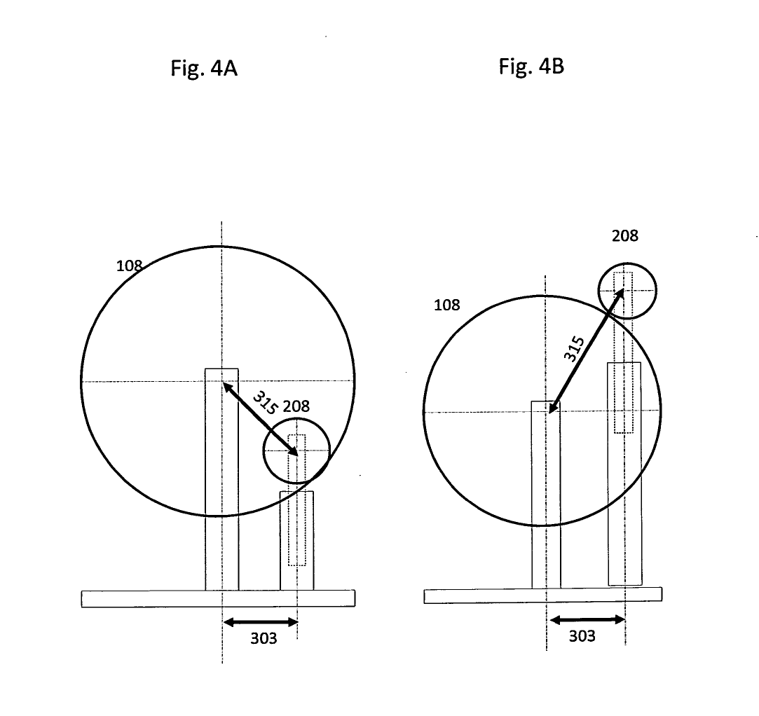

The distances between centers of wheels is a variable component, and is shown in FIGS. 4A and 4B. The base holds the constant predetermined distance 303, such distance is the horizontal projection of the distance between the centers of the two wheels 315. Such distance 303 offsets the center of the second wheel 208 from the dead weight line 101 of the first wheel 108. The dead weight line 101 is formed by points: 103 and 105 as shown in FIG. 1.

The shaft of the smaller wheel while horizontal and parallel to the shaft of the larger wheel is never located at vertical line 101 formed by the center, top, and bottom of the larger or first wheel 108.

The principle of the invention is similar to the effect that a pet hamster has in a rotating wheel in its cage. The challenge is: the way to keep the weight of the hamster at a point around 60 to 89 grades from the vertical central line of the first wheel, instead of the hamster lying at the bottom of the wheel. As shown in drawings 5A and 5B.

The free rotational movement of the larger wheel is allowed by low friction bearings or any other low friction hub system at the center of the wheel. The larger wheel stands vertically, and the shaft stands horizontal in the illustration, but the embodiment is not limited to it. The shafts or axis of the larger wheel 108 and smaller wheel 208 are parallel and horizontal.

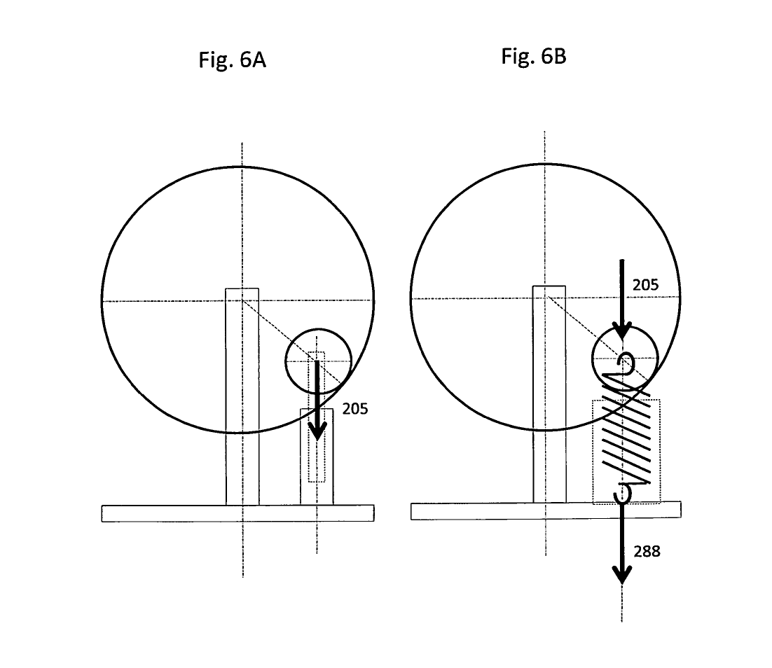

An enhanced tangential force, as shown in FIG. 6B is provided when the second column 204 or vertical arrangement is supporting a heavy piece, or sprung mass that by means of a shaft, is attached to a free rotating smaller wheel 208. This smaller wheel will be allowed to rotate in the perimeter of the larger wheel 108, moved by its own weight or attached weight and spring force.

The heavy piece—electricity generator-shaft and smaller wheel are called the “hamster wheel” and it's mounted on the suspension column, which allows vertical displacement in the direction of the weight, but does not allow horizontal displacement. The shaft of the smaller wheel is allowed to rotate freely in either direction—clockwise or counter clockwise-, depending on the relative location of the smaller wheel 208 with respect to the axis location of the larger wheel 108.

Both wheels can be manufactured as matching gears. Or they can also be manufactured as a wheel with a friction surface that helps the rotational movement of the smaller wheel

The base 301, columns 104 and 204 and wheels 108 and 208 are manufactured of material strong enough to sustain the relative positions, weight, and forces in the device. While steel metal is the most common construction method, new composite material might be used as well.

Bearings or friction reduction devices are used at the center of wheel 108. In a similar way, spacing and friction reduction surfaces are used in the suspension mechanism or sliding column 204, to allow the easy vertical displacement of the sliding mechanism of such column.

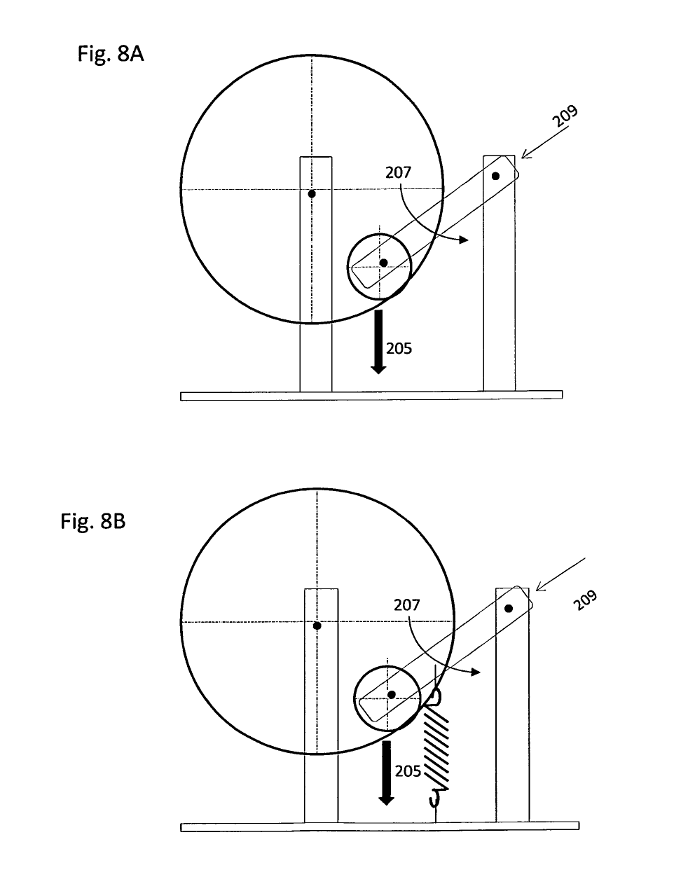

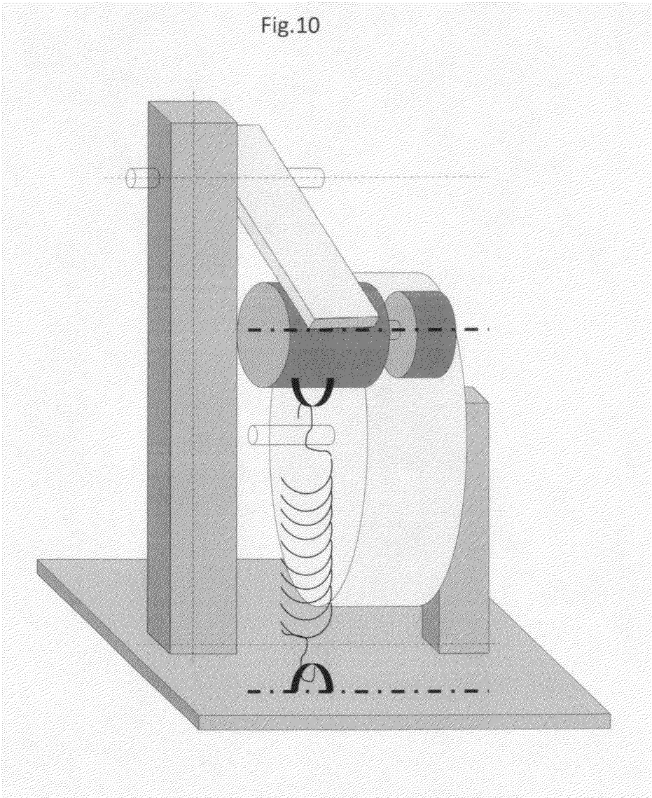

While the invention is shown in only a couple of its forms, it is not thus limited but is susceptible to various changes and modifications without departing from the spirit and scope of the invention. As shown in FIGS. 8A, 8B and 10 but not limited to it.

### Operation—FIGS. 1, 2, 3, 7, 9 and 10

The most optimal ways of using the device is: Electricity generation. By selecting a properly sized electric generator 202, and attaching a wheel or gear 208 at the end of the generators shaft, as shown in FIGS. 1, 2, 3, and 10. In this case the weight force of the generator, augmented with spring force is passed to the smaller wheel as a tangential force 405. The generator will be able to generate an electrical output on the RPM's given by the embodiment. Recommended generators will be of different RPM's than the generators used in gasoline or diesel generators, since RPM's are lower in this embodiment. Weight or sprung mass are added to the system to provide a larger tangential force and higher RPM's and power output.

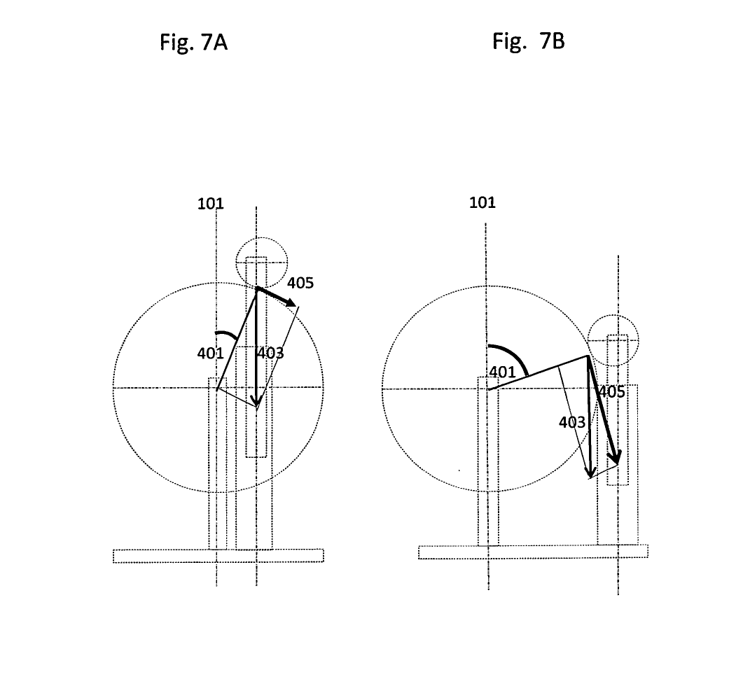

The highest tangential force and most optimal arrangement is when wheel 208 is close to the 90 degree position from dead line 101, as shown in FIG. 7B.

The arrangements shown here were designed to use off the shelf parts and components, such as pinion gears and electric generators.

The plurality of magnets and coils that form an electric generator could also be embedded within wheel 108; providing the relative motion required between magnets and copper windings to generate electricity.

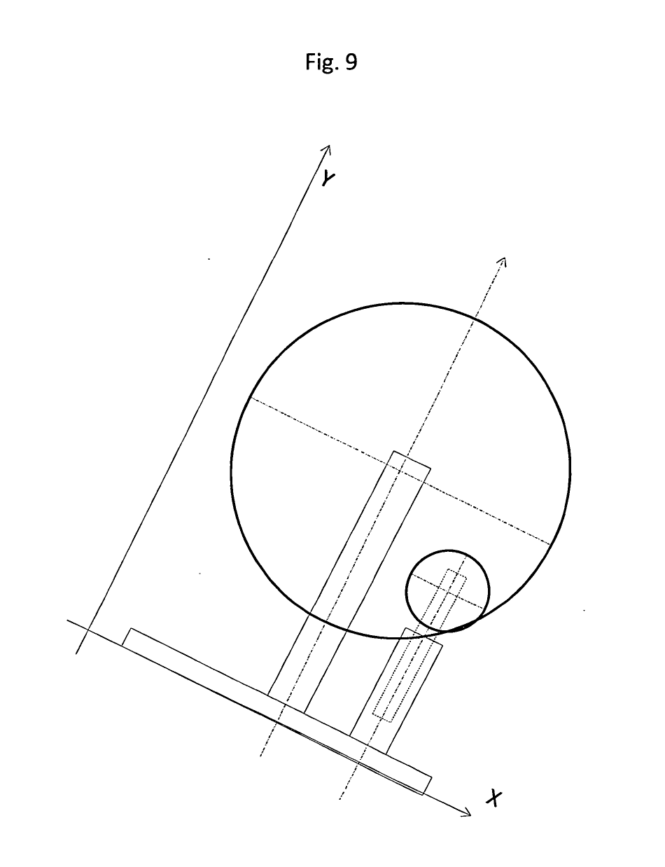

Spring loaded forces can also be of help in instances where the arrangement is not in the perfect vertical position, and provides help when the embodiment is tilted, as is the case in the soft swing motion inside a sea ship, and described by FIG. 9.

Adding weight on the sliding column to increase tangential force in also a mean to increase rotational output, similarly the base and columns must also sustain the new added weight force.

### ADVANTAGES

From the description above, a number of advantages of some embodiments of my collector of rotational movement become evident.
(a) A use in remote areas where electricity is not available for water pumping, as well as electricity generation.
(b) Easy to relocate generation of electricity for frequently moving operations, or nomadic populations, such as contractors, building crews in brown fields, migrating European Gipsy known as Roma and dessert dwellers.
(c) Sea ships vessels use diesel electric generators, to move the impeller moving the ship. This arrangement would reduce fossil consumption in large vessels.

### CONCLUSION, RAMIFICATIONS, AND SCOPE

Accordingly the reader will see that the “Collectors of Rotational Movement” of the various embodiments can be used to pump water, or generate electricity and replace fossil fuels, by properly sizing the pumps and generators to the specific rpm's of the embodiment. Most of the times the pumps and generators might need be resized since rpm's are dependent on the diameter ratios of the wheels of the embodiment, and the quality of its parts, such as bearings and friction minimizing columns, which will affect rpm's output.

It permits the production of electricity without fossil fuels in hotels and commercial shopping plazas, which have the highest consumption and cost rates in the economy. It allows the production of electricity without fossil fuels in sea vessels, either cargo or passenger cruise, the largest consumers of fossil fuel motors.

It provides remotely located communities off the electrical grid, access to electricity. It provides an option to large damns being built on rivers to generate electricity, avoiding the destruction of forests.

Although the description above contains many specifications, these should not be construed as limiting the scope of the embodiment but as merely providing illustration of some of several embodiments, since several arrangements are possible but the inner concept the same.

1. An active rotation system comprising:
a) A base having a fixed column and a free rotating wheels mounted on it for enabling said wheels to have no friction or low rotational friction at its axis (102; 202).
b) A suspension arm mechanism (204) and free rotating wheel (208) mounted in said suspension arm for allowing both wheels to be in touch and rotate simultaneously producing rotational movement.
c) Means for coupling rotational energy from said wheels to at least one electricity generator or pump.
Wherein the off centered weights force of the wheel on the suspension arm, over the first free rotating wheel generates simultaneous rotation on both: the free rotating wheel in the suspension arm and the free rotating wheel in the column base; as the possible arrangement shown in FIG. 4.

2. In combination, an active rotational system having a suspension arm plus wheel mechanism and means for coupling rotational energy from said: suspension arm plus wheel mechanism to another free rotating wheel mounted on said active rotation system. Possible arrangement are shown in FIGS. 1, 2A, 9 and 10.

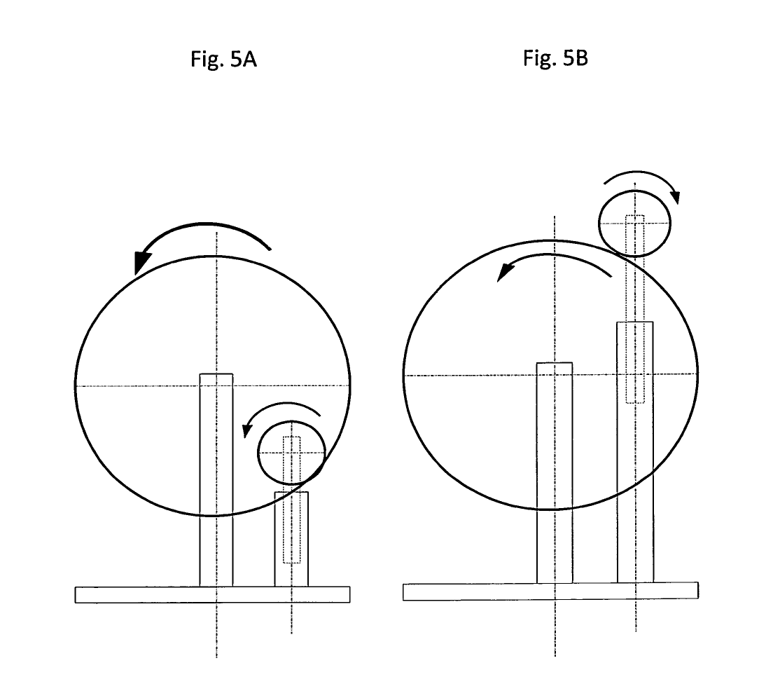

3. The active rotation system of claim 1 wherein the direction of rotation on the first free wheel is similar to the direction of the second rotary wheel. As the same effect in gears, when they are nested within each other. As shown in FIG. 5A.

4. The active rotation system of claim 1 wherein the direction of rotation on the first free wheel rotating is opposed to the direction of the second rotary wheel. As the same effect in gears when they are side by side. As shown in FIG. 5B.

5. The active rotation system of claim 1 wherein: it contains a rigid base of material of strenght enough to sustain the weight and torque of the pieces mounted on it.

6. The active rotation system of claim 1 wherein: the column base (104) contains means to attach the axis of a free rotating wheel.

7. The active rotation system of claim 1 wherein: The rigid base has means to hold distance 303 between the fixed column and the sliding arm, allowing both wheels to be in contact at their perimeter and rotate simultaneously.

8. The active rotation system of claim 1 wherein: The rigid base has means to hold the axis of the first and second rotating wheels arranged in parallel; and the wheels rotating in contact with each other on their perimeter; as the possible arrangement shown in FIGS. 3A and 3B.

9. The active rotation system of claim 1 wherein: The active suspension arm comprises: a plurality of parts for allowing a free linear vertical displacement; and no displacement in the horizontal direction.

10. The active suspension arm of claim 9 comprises: two pieces or more for allowing a linear vertical displacement with no or low friction.

11. The active suspension arm of claim 9 wherein: The sliding piece of the suspension arm has means to hold the second free rotating wheel. Either directly FIG. 2B, or indirectly thru a generator, as shown in FIG. 2A, and FIG. 1.

12. The active suspension arm of claim 9 comprises a spring mechanism with means to attach the sliding arm at one end of the spring, and the fixe base at the other end of the spring.

13. The active suspension arm of claim 9 wherein: A spring mechanism provides additional force to reinforce speed at the point of contact of the two wheels, as shown in FIG. 6B.

14. The active rotation system of claim 1 wherein: The active suspension arm comprises: a plurality of parts for allowing an angular displacement and no radial displacement. As the possible arrangement shown in FIG. 8A.

15. The active suspension arm of claim 14 provides means for allowing an angular displacement with no or low friction.

16. The active suspension arm of claim 14 of material providing enough rigidity to sustain the weight, momentum and torque of the pieces mounted on it.

17. The active suspension arm of claim 14 comprises a spring mechanism with means to attach the sliding arm at one end of the spring, and the fixe base at the other end of the spring.

18. The active suspension arm of claim 14 comprises a spring mechanism that provides additional force to reinforce speed at the point of contact of the two wheels, as shown in FIG. 8B.

19. The active rotation system of claim 1 wherein: In combination, an active rotational system having a suspension arm and wheel mechanism and means for coupling rotational energy from said: suspension arm and wheel to a generator mounted on said active rotation system. A possible arrangement is shown in FIGS. 6B, 8B and 10.

20. The active rotation system of claim 1 wherein: In combination, an active rotational system having a free rotating wheel and base mechanism and means for coupling rotational energy from said: free rotating wheel and base to a generator mounted on said active rotation system.
